(19) United States
(12) Patent Application Publication
(10) Pub. No.: US 2018/0062356 A1
(43) Pub. Date: Mar. 1, 2018

(54) IGNITION CONTROL SYSTEM

(71) Applicant: DENSO CORPORATION, Kariya-city (JP)

(72) Inventors: Ken HANASHI, Kariya-city (JP); Ryohei AKlYOSHI, Kariya-city (JP); Tomoyuki WATANABE, Kariya-city (JP)

(21) Appl. No.: 15/690,756

(22) Filed: Aug. 30, 2017

(30) Foreign Application Priority Data
Aug. 31, 2016 (JP) 2016-169758

(51) Int. Cl. H01T 13/32; H01T 13/39; H01T 21/02

(52) U.S. Cl. CPC H01T 13/32; H01T 21/02; H01T 13/39

(57) ABSTRACT

In the spark plug, at least one of the center chip and the ground chip is bonded with a center electrode or a ground electrode. The selected chip has a first part formed so as to linearly extend along a first center axis of an electrode bonded with the first part and a second part formed so as to extend linearly from a tip end of the first part along a second central axis inclined with respect to the first central axis.

This application is based on and claims the benefit of priority from earlier Japanese Patent Application No. 2016-169758 filed on Aug. 31, 2016, the description of which is incorporated herein by reference.

### TECHNICAL FIELD

This disclosure relates to a spark plug for an internal combustion engine.

### BACKGROUND

A spark plug for igniting a gas mixture in a combustion chamber is included in an internal combustion engine. In the spark plug, spark discharge occurs between electrodes spaced apart from each other, thereby igniting the gas mixture.

Various shapes and positions of the electrodes of the spark plug have been proposed before. Japanese Unexamined Patent Application Publication No. 2002-324650 will be referred to as patent document 1. For example, a spark plug described in patent document 1 is provided with a center electrode having a center electrode chip and a ground electrode having a ground electrode chip. The center electrode is disposed inside of a mounting fitting, and the ground electrode is disposed on a tip end of the mounting fitting. In the spark plug, the spark discharge occurs between a tip end face of the center electrode chip and a tip end face of the ground electrode chip.

In the spark plug, a part of the ground electrode having the ground electrode chip is non-perpendicular to a center axis of the mounting fitting. Thus, a direction from the ground electrode chip to the center electrode chip is non-perpendicular to a center axis of the center electrode. In addition, the ground electrode chip extends from a side face of the ground electrode to the center axis of the center electrode.

In such a configuration, a wider space between the ground electrode and the center electrode is secured in comparison to a configuration where the ground electrode extends to a position above the center electrode (i.e. position where the center axis of the center electrode and the center axis of the ground electrode are overlapped). Therefore, it is possible to prevent a phenomenon in which flame kernel occurring at a vicinity of the center electrode contacts with the surface of the ground electrode and in which a growth of the flame kernel is inhibited from occurring, and it is possible to exhibit excellent ignition performance. In addition, in the above-described configuration, it is also possible to obtain an effect that heat dissipation properties of the ground electrode become sufficient because the ground electrode is shortened.

In patent document 1, the center electrode chip mounted on the tip end of the center electrode is disposed non-perpendicular to the center axis of the center electrode. Thereby, the tip end face of the center electrode chip and the tip end face of the ground electrode chip face each other in a mutually parallel state. In such a configuration, even when a part of the center electrode chip is consumed with an occurrence of the spark discharge, a distance between the center electrode chip and the ground electrode chip, that is a discharge distance, may be constant. As a result, ignition performance of the spark plug may be stably maintained over a long period.

Like the spark plug described in patent document 1, in the spark plug having a configuration in which the ground electrode is non-perpendicular to the center axis of the mounting fitting, there is a problem that chips are difficult to be welded to respective electrodes when the tip end faces of the chips face each other in a mutually parallel state. This is because an installation and a condition needed to weld the chips to the electrodes are different from conventional ones when a center axis of each of the chips is non-perpendicular to a center axis of each of the electrodes which is an object of bonding. It is preferable that the center axis of the chip in a bonding part is perpendicular to a bonding face of the electrode for easily welding the chip to the electrode.

### SUMMARY

The present disclosure provides a spark plug which is capable of easily welding chips to the center electrode and the ground electrode. The spark plug has a configuration in which a ground electrode is non-perpendicular to a center axis of a mounting fitting and in which the tip end face of the ground electrode and the tip end face of the center electrode face each other in a mutually parallel state.

The spark plug according to the present disclosure is a spark plug for an internal combustion engine, and has a cylindrical mounting fitting, the center electrode, a center chip, a ground electrode and a ground chip. The center electrode is disposed along the center axis of the mounting fitting, and is mounted on the mounting fitting in an electrically insulated state relative to the mounting fitting. The center chip is projected from a part of the center electrode to outside of the spark plug. The ground electrode has a first end and a second end. The first end of the ground electrode is fixed by the mounting fitting. At least a part of the ground electrode is non-perpendicular to the center axis of the mounting fitting so that the ground electrode becomes closer to the center axis of the mounting fitting towards the second end of the ground electrode. The ground chip is projected from the part of the ground electrode to the center chip. The center chip is bonded with the center electrode, and the ground chip is bonded with the ground electrode. The center chip has a first part and a second part. The first part extends linearly along a first center axis of the center electrode. The first part has a first end and a second end, and the second end of the first part is bonded with the center electrode. The second part linearly extends from the first end of the first part along a second center axis which is non-perpendicular to the first center axis.

In such a configuration of the spark plug, the center chip has the first part and the second part whose directions of the center axes are different from each other. As a result, the whole of the center chip is formed in bent state. Therefore, a shape of the first part, which is a part bonded with the center electrode, may be suitable for welding work. In addition, a shape of the tip end of the second part, which is an origin of the spark discharge, may be suitable for improving ignition performance. The center chip has a first end and a second end. Shapes of the first end and the second end of the center chips may be determined independently of each other.

As an example of the shape of the first part as a shape suitable for welding work, for example, the end face of the first part at a position opposed to the center electrode is perpendicular to the first center axis. Thereby, the first part may be perpendicularly bonded with a bonding face of the center electrode. As an example of the shape of the second part as a shape suitable for improving ignition performance, for example, the end face of the tip end of the second part, which is opposed to the ground chip, is perpendicular to the second center axis. Thereby, tip faces of two chips (center chip and ground chip) are arranged in a mutually parallel state.

Incidentally, the second part extended from the first end of the first part may also be directly bonded with the tip end face of the first part, and may also be indirectly bonded with the first end face of the first part via another member which is made of one or more layers.

The present disclosure provides the spark plug which is capable of easily welding the chips to the center electrode and the ground electrode. The spark plug has the configuration in which the ground electrode is non-perpendicular to the center axis of the mounting fitting and in which the tip faces of the chips face each other in the mutually parallel state.

### BRIEF DESCRIPTION OF THE DRAWINGS

In the drawings:

FIG. 1 shows an overall configuration of a partial sectional view of a spark plug according to a first embodiment of the present disclosure;

FIG. 2 shows an enlarged view of a part producing spark discharge in the spark plug shown in FIG. 1;

FIG. 3 shows a perspective view of a center chip of the spark plug;

FIG. 4A and FIG. 4B show a diagram for explaining the center chip;

FIG. 5 shows a perspective view of a center chip of a spark plug of a modification of the first embodiment;

FIG. 6 shows a perspective view of a center chip of a spark plug according to a second embodiment of the present disclosure;

FIG. 7 shows a perspective view of a center chip of a spark plug according to a third embodiment of the present disclosure;

FIG. 8 shows a perspective view of a center chip of a spark plug according to a fourth embodiment of the present disclosure;

FIG. 9 shows a perspective view of center chip of a spark plug according to a fifth embodiment of the present disclosure;

FIG. 10 shows an enlarged view of a part of occurring spark discharge in a spark plug according to a sixth embodiment of the present disclosure;

FIG. 11 shows an enlarged view of a part of occurring spark discharge in a spark plug according to a seventh embodiment of the present disclosure;

FIG. 12 shows an enlarged view of a part of occurring spark discharge in a spark plug according to an eighth embodiment of the present disclosure;

FIG. 13 shows an enlarged view of a part where spark discharge occurs in a spark plug according to a ninth embodiment of the present disclosure; and

FIG. 14 shows a perspective view of a center chip of a spark plug according to a tenth embodiment of the present disclosure.

### DETAILED DESCRIPTION OF THE PREFERRED EMBODIMENTS

An embodiment of the present disclosure will be described below referring to the drawings. It should be appreciated that, in the each of the drawings, components identical with or similar to those in the first embodiment are given the same reference numerals, and repeated structures and features thereof will not be described in order to avoid redundant explanation.

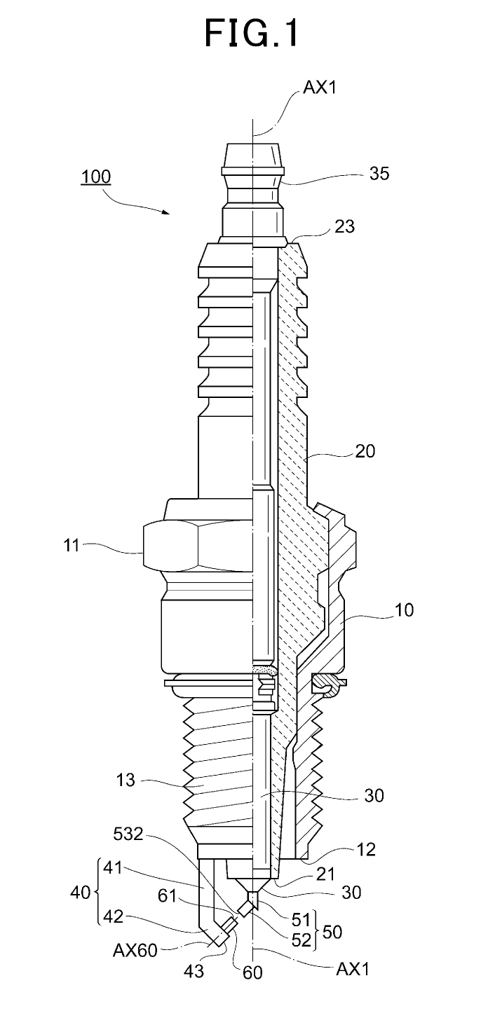

A configuration of a spark plug 100 according to a first embodiment will be described below referring to FIG. 1. The spark plug 100 is an apparatus for producing a spark discharge in a combustion chamber of an internal combustion engine (not shown) and igniting gas mixture in the combustion chamber. The spark plug 100 has a mounting fitting 10, an insulator 20, a center electrode 30 and a ground electrode 40.

The mounting fitting 10 is a part mounted on the internal combustion engine. The entire mounting fitting 10 has a cylindrical shape, and the insulator 20 and the center electrode 30 described later are mounted therein. A male screw part 13 and a hexagonal nut part 11 are formed on an outside face of the mounting fitting 10. The male screw hole part 13 is inserted into a screw hole (female screw-processed hole on an internal wall face) formed on a wall of the internal combustion engine and is fixed. When the spark plug 100 is mounted on the internal combustion engine, a worker rotates the hexagonal nut part 11 using a tool such as a torque wrench, and fastens and fixes the spark plug 100 relative to the screw hole. When the spark plug 100 is mounted on the internal combustion engine, the center electrode 30 and the ground electrode 40 are arranged in the combustion chamber of the internal combustion engine.

The insulator 20 is a member for securing electrical insulation between the mounting fitting 10 and the center electrode 30. The insulator 20 is made of an alumina ceramic in the present embodiment. The entire insulator 20 has a cylindrical shape, and has the center electrode 30 therein. The insulator 20 is fixed relative to the inside face of the mounting fitting 10 in such a state that a center axis AX1 thereof is aligned with a center axis of the mounting fitting 10. An end 21 of the insulator 20 disposed at the combustion chamber side (upper side of FIG. 1) of the spark plug 100 is projected from an end 12 of the mounting fitting 10 to an outside of the spark plug (lower side of FIG. 1). In addition, an end 23 of the insulator 20, which is opposed to the end 21 disposed at the combustion chamber side is projected from the mounting fitting 10 to the outside of the spark plug (upper side of FIG. 1).

A terminal 35 has a first part and a second part. The first part of the terminal 35 for applying a voltage to the center electrode 30 is housed in the insulator 20. The second part of the terminal 35 is projected from the end 23 of the insulator 20 to the outside of the spark plug. A current flows from the terminal 35 to the center electrode 30 via a resistor.

The center electrode 30 is a member, which has a cylindrical shape, and is made of a nickel-based alloy having nickel as a main ingredient. The center electrode 30 is fixed in the insulator 20 in such a state that a center axis thereof is aligned with the center axis AX1 of the mounting fitting 10. That is, the center electrode 30 is arranged along the center axis AX1 of the mounting fitting 10. An end of the center electrode 30, which is disposed at the combustion chamber side, is projected from the end 21 of the insulator 20 to the outside of the spark plug (lower side of FIG. 1). As shown in FIG. 1, a part of the center electrode 30 projected from the end 21 of the insulator 20 has a taper shape whose diameter becomes smaller towards a tip end of the center electrode 30 (lower side of FIG. 1). The center electrode 30 is mounted on the mounting fitting 10 in an electrically insulated state.

A center chip 50 is mounted on the tip end of the part of the center electrode 30 projected from the end 21 of the insulator 20, which is opposed to the combustion chamber. The center chip 50 and a ground chip 60 described later are parts of an origin of the spark discharge, and the center chip 50 is mounted on the center electrode 30 so as to be projected from the part (tip end) of the center electrode 30. A concrete shape of the center chip 50 will be described later.

The ground electrode 40 is a member which is made of a nickel-based alloy having nickel as a main ingredient. The ground electrode 40 has substantially a prismatic shape. The ground electrode 40 has a first end and a second end. The first end of the ground electrode 40 is welded to the end 12 of the mounting fitting 10 disposed at the combustion chamber side, and is fixed. As shown in FIG. 1, a part of the end 12 of the mounting fitting 10 fixed to the ground electrode 40 is offset from the center axis AX1 of the mounting fitting 10. The tip end 43 of the ground electrode 40, which corresponds to the second end of the ground electrode 40, is projected from the end 12 of the mounting fitting 10 to the combustion chamber.

A center axis of a part in a vicinity of the end 12 of the ground electrode 40 that is a part given a reference numeral 41 of FIG. 1 is substantially arranged parallel relative to the center axis AX1 of the mounting fitting 10. A center axis of a part of the tip end 43 of the ground electrode 40 that is a part given a reference numeral 42 of FIG. 1 is non-perpendicular to the center axis AX1 of the mounting fitting 10. Specifically, the part given the reference numeral 42 is non-perpendicular to the center axis AX1 of the mounting fitting 10 so as to become closer to the center axis AX1 of the mounting fitting 10 towards the tip end 43 of the ground electrode 40. Incidentally, when viewing the ground electrode 40 along the center axis AX1 of the mounting fitting 10, the ground electrode 40 and the center axis AX1 of the mounting fitting 10 do not overlap each other.

A ground chip 60 is mounted on a vicinity of the tip end 43 of the ground electrode 40. The ground chip 60 of the present embodiment is a member which is made of a noble metal alloy including platinum as a base material, and has a cylindrical shape. A noble metal alloy including iridium as a base material may also be used as a material of the ground chip 60.

The ground chip 60 has a first end and a second end. The first end of the ground chip 60 is welded and fixed to a side face 421 of the ground electrode 40, which is disposed at a position opposed to the center axis AX1 of the mounting fitting 10. A center axis AX60 of the ground chip 60 is perpendicular to the side face 421 of the ground electrode 40. As a result, the ground chip 60 is projected from a part of the ground electrode 40 to the center chip 50. In addition, a center axis AX60 of the ground chip 60 is non-perpendicular to the center axis AX1 of the mounting fitting 10. A tip end face 61 of the ground chip 60, which corresponds to the second end of the ground chip 60, is perpendicular to the center axis AX60 of the ground chip 60, and is opposed to a tip end face 522 described later of the center chip 50.

A space where the spark discharge occurs is formed between the center chip 50 and the ground chip 60 which are separated from each other. A high voltage is applied between the mounting fitting 10 and the terminal 35 during an operation of the internal combustion engine. Thereby, the spark discharge occurs between the center chip 50 and the ground chip 60.

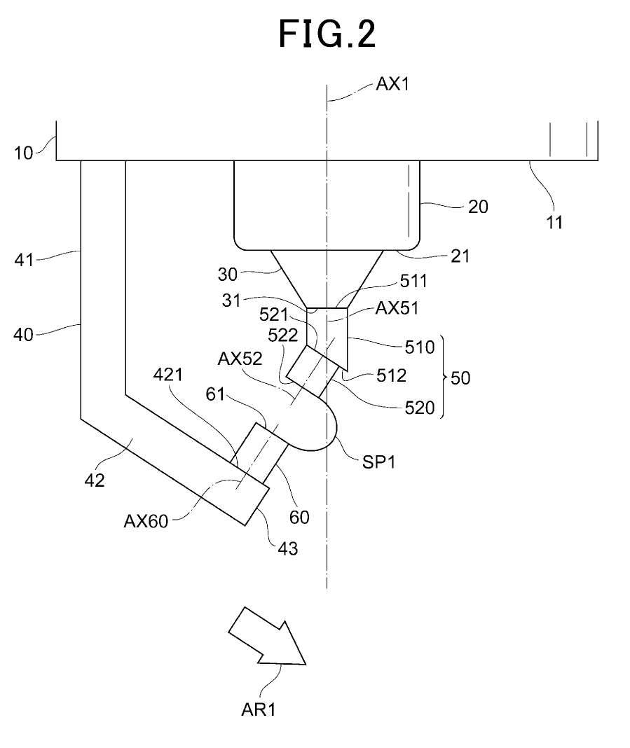

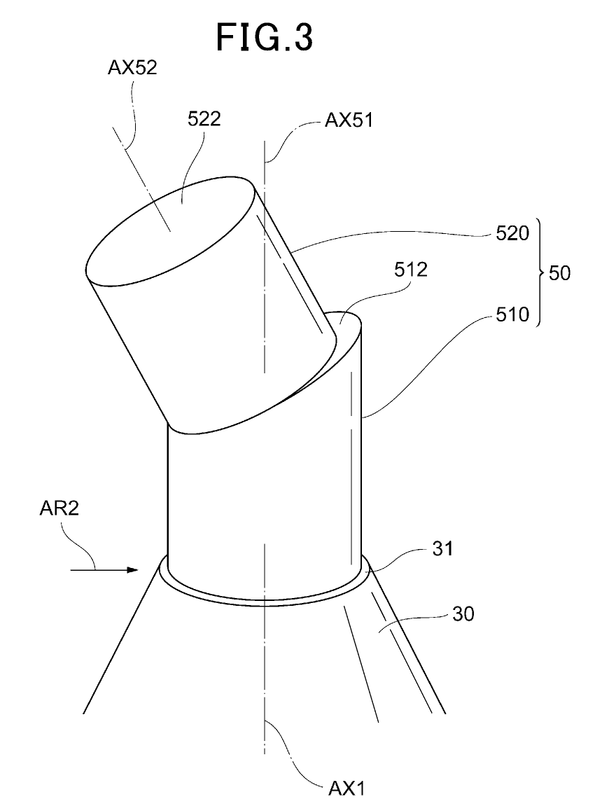

A concrete shape of the center chip 50 will be described by referring to FIGS. 2 and 3. FIG. 2 shows an enlarged view of a part where the spark discharge occurs in the spark plug 100, in a vicinity of the center chip 50 together with the ground chip 60. FIG. 3 shows a perspective view of the center chip 50. Incidentally, the center chip 50 of FIG. 3 is drawn in such a state that a view shown in FIG. 2 is inverted vertically.

The center chip 50 has a first part 510 and a second part 520, and is formed by, for example, diffusion bonding the first part 510 and the second part 520. The first part 510 is a part of the center chip 50 disposed at the center electrode 30, and is a part bonded with a tip end face 31 of the center electrode 30. The first part 510 is made of an alloy including nickel as a base material in the same way as the center electrode 30. The first part 510 has an approximately cylindrical shape. The first part 510 linearly extends from the tip end face 31 of the center electrode 30 along a center axis AX51 of the first part 510. The center axis AX51 of the first part 510 is aligned with the center axis AX1 of the mounting fitting 10. The center axis AX51 of the first part 510 corresponds to a first center axis of the present embodiment.

The tip end face 31 of the center electrode 30 is perpendicular to the center axis AX1 of the mounting fitting 10. In addition, an end face 511 of the first part 510 disposed at the position opposed to the center electrode 30 (i.e. end face which is disposed apart from a second part 520) is perpendicular to the center axis AX51 of the first part 510. The first part 510 is welded and fixed in such a state that the end face 511 of the first part 510 is mounted on a center of the tip end face 31 of the center electrode 30. As a result, the first part 510 is connected with the tip end face 31 of the center electrode 30 so that the center axis AX51 thereof is perpendicular to the tip end face 31 of the center electrode 30.

A side face 512 of the first part 510 disposed at a position opposed to the second part 520 is non-perpendicular to the center axis AX1 of the mounting fitting 10 and the center axis AX51 of the first part 510. The side face 512 of the first part 510 is perpendicular to the center axis AX 60 of the ground chip 60. In other words, the side face 512 of the first part 510 and a side face 412 of the ground electrode 40 face each other and are mutually parallel.

The second part 520 is a part of the center chip 50 disposed at a position opposed to the ground chip 60. The second part 520 is a member which is made of a noble metal alloy (i.e. alloy including platinum) including platinum as a base material in the same way as the ground chip 60, and has a cylindrical shape. A noble metal alloy (i.e. alloy including iridium) including iridium as a base material may also be used as a material of the second part 520.

The second part 520 linearly extends from the side face 512 of the first part 510 along the center axis AX52 of the second part 520. Both the side face 521 of the second part 520 disposed at a position opposed to the first part 510 and the tip end face 522 of the second part 520 disposed at a position opposed to the ground chip 60 are perpendicular to the center axis AX52 of the second part 520. The center axis AX52 of the second part 520 is aligned with the center axis AX 60 of the ground chip 60. Therefore, the tip end face 522 of the second part 520 and the tip end face 61 of the ground chip 60 face each other and are mutually parallel. The center axis AX52 corresponds to a second center axis of the present embodiment.

Effects of the above-described configuration of the spark plug will be described below. As shown in FIG. 2, in the present embodiment, the tip end 43 of the ground electrode 40 does not extend to a position above the center electrode 30 (i.e. position where the center axis AX1 of a mounting fitting 10 and the ground electrode 40 are overlapped). Therefore, a wider space between the ground electrode 40 and the center electrode 30 is secured. Therefore, it is possible to prevent a phenomenon in which a flame kernel produced in a vicinity of the center electrode 30 contacts with the surface of the ground electrode 40 and in which a growth of the flame kernel is inhibited from occurring, and it is possible to exhibit excellent ignition performance. In addition, in the above-described configuration, it is possible to obtain an effect that heat dissipation properties of the ground electrode 40 become sufficient because the ground electrode 40 is shortened.

In a configuration where the ground electrode 40 is non-perpendicular to the center axis AX1 of the mounting fitting 10 like the present embodiment, airflow tends to flow along a direction of an arrow ARI of FIG. 2 by flowing the airflow in the combustion chamber along the ground electrode 40. A path of the spark discharge occurring between the center chip 50 and the ground chip 60 and shaped by the airflow is a path given a reference numeral SP1 of FIG. 2 that is a path extending to a space formed at a bottom right of the ground chip 60 of FIG. 2. The space formed at a bottom right of the ground chip 60 of FIG. 2 is kept free by a slope of the ground electrode 40. Therefore, in the present embodiment, a relatively large spark is easily formed, and the ignition performance of the spark plug 100 is improved.

In the present embodiment, the tip end face 61 of the ground chip 60 and the tip end face 522 of the center chip 50 face each other and are mutually parallel. Therefore, even when a part of the ground chip 60 or the like is consumed by an impact of the spark discharge, a distance between the center chip 50 and the ground chip 60 that is a discharge distance may be constant without changing. As a result, it is possible to stably produce the spark discharge, and the ignition performance of the spark plug 100 may be stably maintained over a long period.

The above-described configuration is a configuration in which the ground electrode 40 is non-perpendicular to the center axis AX1 of the mounting fitting 10 and in which tip end faces of chips of a center electrode and a ground electrode face each other in a mutually parallel. A configuration may also be considered which is different from the above-described configuration. For example, it is also considered that the tip end face 31 of the center electrode 30 may be non-perpendicular to the center axis AX1 of the mounting fitting 10 and a cylindrical tip is bonded with the tip end face 31 of the center electrode 30. In addition, it is also considered possible that an end face of the center chip 50 disposed at the position opposed to the center electrode 30, which is obliquely cut, may be bonded with the tip end face 31 of the center electrode 30.

However, in such a configuration, the center chip 50 needs to be welded to the center electrode 30 in such a state that it is non-perpendicular to the center electrode 30. Therefore, an installation and a condition needed to weld the center chip 50 to the center electrode 30 are different from conventional ones. As a result, there is a risk that welding work may be difficult to perform.

On the other hand, in the present embodiment, a part of the center chip 50 is disposed at the position opposed to the center electrode 30 that is the first part 510 as a part welded to the center electrode 30 which is perpendicular to the tip end face 31 of the center electrode 30. In addition, the first part 510 extends along a longitudinal direction (center axis AX1) of the center electrode 30. Therefore, as shown by the arrow AR2 of FIG. 3, a direction where a laser for welding the center electrode 30 is emitted is perpendicular to the center axis AX1 of the mounting fitting 10. In addition, when a welding position changes along a circumferential direction of the tip end face 31 of the center electrode 30, it is possible to maintain a welding direction and a height of a welded part (position disposed along the center axis AX1 of the mounting fitting 10). Furthermore, the center chip 50 is not inclined in the welded part, therefore, it is possible to perform welding equally over the whole circumferential direction of the tip end face 31 of the center electrode 30. As a result, in the present embodiment, it is possible to easily weld the center chip 50 to the center electrode 30 using the same procedure as a conventional one.

As described above, in the present embodiment, the first part 510 of the center chip 50 bonded with the center electrode 30 has a shape which is suitable for welding work. In addition, the second part 520 disposed at a position opposed to an origin of the spark discharge has a shape which is suitable for improving the ignition performance. That is, one of ends of the center chip 50 and the other one of the ends of the center ship 50 are determined independently respectively so as to have respectively shapes which are suitable for respective functions.

In addition, an effect of reducing an amount of a noble metal alloy used may be obtained by using a noble metal alloy which has high durability against the spark discharge, for a part of the center chip 50 other than the whole center chip 50.

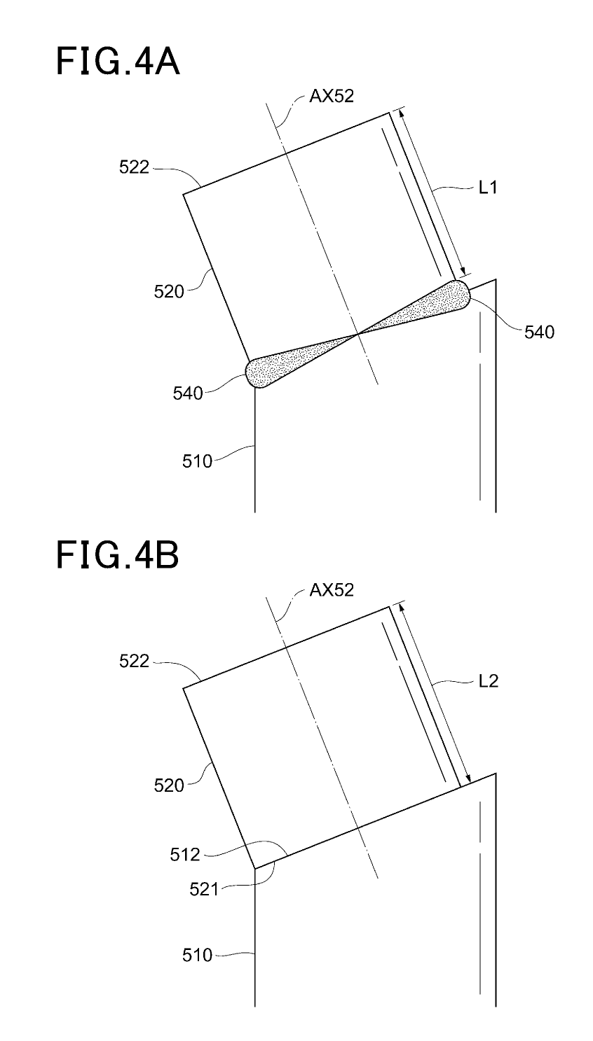

Incidentally, in the present embodiment, the first part 510 and the second part 520 are diffusion bonded with each other. Instead of the above-described aspect, it is also possible to weld the first part 510 to the second part 520. However, as shown in FIG. 4 (A), a length L1 of the second part 520 along the center axis AX52 of the second part 520 is liable to be shorter than an initial length of the second part 520 along the center axis AX52. This is because a melting part 540 melted by welding is formed between the first part 510 and the second part 520. The length L1 of the second part 520 is preferably secured to be sufficiently long from a viewpoint of widely securing an area which will be the origin of the spark discharge.

Like the present embodiment, if the first part 510 and the second part 520 are diffusion bonded with each other, the melting part 540 is not formed. As a result, as shown in FIG. 4(B), it is possible that the length of the second part 520 along the center axis AX52 of the second part 520 is a length 2 which is almost equal to the initial length of the second part 520 along the center axis AX52. Thereby, the ignition performance of the spark plug 100 is further improved.

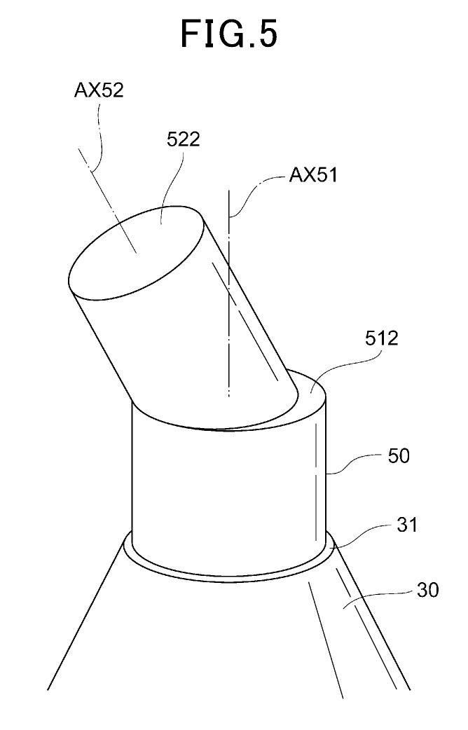

A modification of the first embodiment will be described below by referring to FIG. 5. A center chip 50 has a first part 510 and a second part 520. In this modification, an end face 512 of the first part 510 is perpendicular to a center axis AX51 of the first part 510. On the other hand, an end face 521 of the second part 520 that is a face bonded with an end face 512 is non-perpendicular to a center axis AX52 of the second part 520. Incidentally, a tip end face 522 of the second part 520 is perpendicular to the center axis AX52 of the second part 520 in the same way as in the first embodiment.

Like this modification, a configuration where the end of the second part 520 is obliquely cut instead of the first part 510 may also obtain the same effect as in the first embodiment. Incidentally, the second part 520 made of a noble metal has poor workability, therefore, like the first embodiment, it is preferable that the end of the first part 510 is obliquely cut.

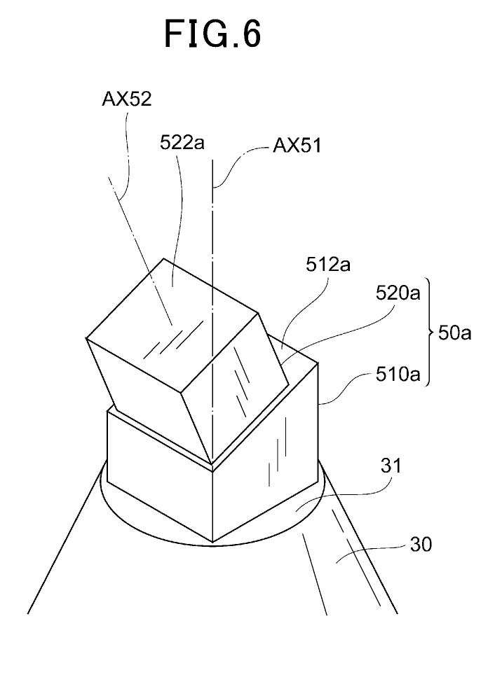

A second embodiment will be described below by referring to FIG. 6. A spark plug 100 according to the second embodiment is different from the first embodiment in only a shape of a center chip 50a. Other configurations are the same as those in the first embodiment. Different points in the second embodiment compared to the first embodiment will be described below. Points that are the same as in the second embodiment and the subsequent embodiments will not be described in order to avoid redundant explanation.

The center chip 50a has a first part 510a and a second part 520a. In the present embodiment, the first part 510a and the second part 520a are respectively formed so as to have square prism shapes, not cylindrical shapes. The end face of the first part 510a disposed at the center electrode 30 (a part corresponding to an end face 511 in the first embodiment) is perpendicular to a center axis AX51 of the first part 510a. The first part 510a is welded and fixed in such a state that the end face of the first part 510a is mounted on a center of a tip end face 31 of a center electrode 30. As a result, the first part 510a is connected with the tip end face 31 of the center electrode 30 so that the center axis AX51 of the first part 510a is perpendicular to the tip end face 31 of the center electrode 30.

An end face 512a of the first part 510a disposed at a position opposed to the second part 520a is non-perpendicular to the center axis AX51 of the first part 510a. The end face 512a of the first part 510a is perpendicular to a center axis AX60 of a ground chip 60 in the same way as an end face 512 of a first part 510 in the first embodiment.

The second part 520a linearly extends from the end face 512a of the first part 510a along a center axis AX52 of the second part 520a. Both the end face of the second part 520a disposed at a position opposed to the first part 510a (a part corresponding to an end face 521 of a second part 520 in the first embodiment) and a tip end face 522a of the second part 520a disposed at a position opposed to the ground chip 60 are perpendicular to the center axis AX52 of the second part 520a. The center axis AX52 of the second part 520a is aligned with the center axis AX60 of the ground chip 60. Therefore, in the present embodiment, the tip end face 522a of the second part 520a and a tip end face 61 of the ground chip 60 face each other in a mutually parallel. In the above-described aspect, an effect similar to one described in the first embodiment may be obtained.

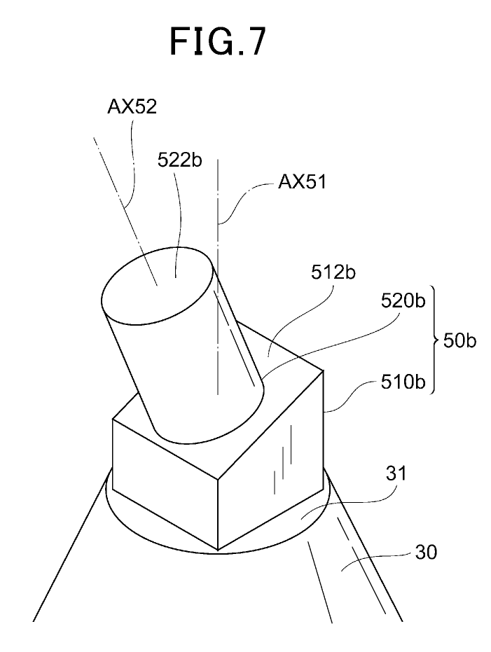

Referring to FIG. 7, a third embodiment will be described below. A spark plug 100 according to the third embodiment is different from the first embodiment in only a shape of a center chip 50b. Other configurations are the same as those in the first embodiment. Different points in the third embodiment compared to the first embodiment will be described below.

The center chip 50b has a first part 510b and a second part 520b. In the present embodiment, the first part 510b has a square prism shape, not a cylindrical shape, and a shape of the first part 510b is equivalent to a shape of a first part 510a in the second embodiment. On the other hand, the second part 520b has a cylindrical shape, and a shape of the second part 520b is equivalent to a shape of a second part 520 in the first embodiment. Therefore, an end face 512b of the first part 510b disposed at a position opposed to the second part 520b is non-perpendicular to a center axis AX51 of the first part 510b, and is perpendicular to a center axis AX60 of a ground chip 60. In addition, a tip end face 522b of the second part 520b disposed at a position opposed to the ground chip 60 is perpendicular to a center axis 52 of the second part 520b. A tip end face 61 of the ground chip 60 face each other in a mutually parallel. In the above-described aspect, an effect similar to one described in the first embodiment may be obtained.

Incidentally, in a shape of a center chip 50b, only the second part 520b disposed at a position opposed to the ground chip 60 may also have a square prism shape instead of that only the first part 510b disposed at a position opposed to a center electrode 30 has the square prism shape like the present embodiment. A cross-section shape of the first part 510b that is a cross-section face which is perpendicular to the center axis AX51 of the first part 510b may be an arbitrary shape. In addition, a cross-section shape of the second part 520b that is a cross-section face which is perpendicular to the center axis AX52 of the second part 520b may be an arbitrary shape.

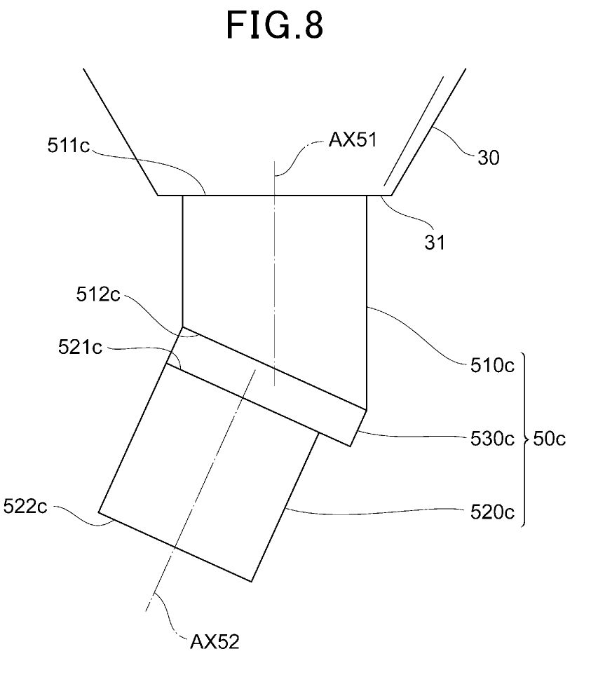

Referring to FIG. 8, a fourth embodiment will be described below. A spark plug 100 according to the fourth embodiment is different from the first embodiment in only a shape of a center chip 50c. Other configurations are the same as those in the first embodiment. Different points in the fourth embodiment compared to the first embodiment will be described below.

The center chip 50c has a first part 510c and a second part 520c. In the present embodiment, a middle layer 530c is formed between the first part 510c and the second part 520c. The middle layer 530c is respectively bonded with an entire end face 512c of the first part 510c and an entire end face 521c of the second part 520c. The middle layer 530c is made of a material that is different from both the materials of the first part 510c and the second part 520c. An alloy including both platinum and nickel is used in a material of the middle layer 530c of the present embodiment. As a result, a linear expansion coefficient of the middle layer 530c is smaller than that of the first part 510c, and is larger than that of the second part 520c. Heat stress between the first part 510c and the second part 520c occurred is moderated by forming the middle layer 530c. Accordingly, it is possible to prevent the center chip 50c from separating if exposed to a cold environment in an internal combustion engine.

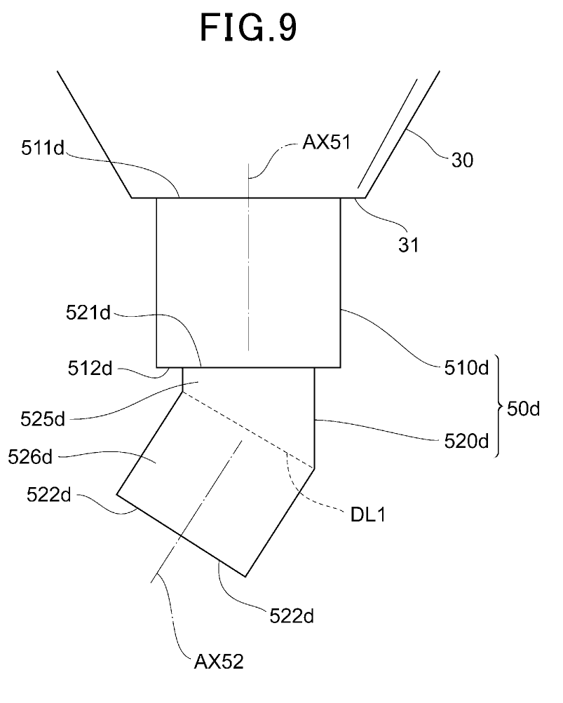

Referring to FIG. 9, a fifth embodiment will be described below. A spark plug 100 according to the fifth embodiment is different from the first embodiment in only a shape of a center chip 50d. Other configurations are the same as those in the first embodiment. Different points in the fifth embodiment compared to the first embodiment will be described below.

The center chip 50d has a first part 510d and a second part 520d. A shape of the first part 510d of the present embodiment has a square prism shape. An end face 511d of the first part 510d disposed at a position opposed to a center electrode 30 and an end face 512d of the first part 510d disposed at a position opposed to the second part 520d are both perpendicular to a center axis AX51 of the first part 510d.

A shape of the second part 520d according to the present embodiment has a square prism shape with a center axis being bent in the middle. A part (hereinafter referred to as a “vertical portion 525d”) of the second part 520d on the first portion 510d side is formed so as to extend perpendicularly to the end face 512d. A center axis of the vertical portion 525d is aligned with the center axis AX51 of the first part 510d. In addition, a center axis AX52 of a part (hereinafter referred to as “inclined portion 526d”) of the second portion 520d on the ground tip 60 side is inclined with respect to the central axis AX51. The center axis AX52 of the inclined portion 526d is aligned with a center axis AX60 of the ground chip 60 in the same way as a center axis AX52 of a second part 520 in the first embodiment. In addition, a tip end face 522d of the inclined portion 526d is perpendicular to the center axis AX52 of the inclined portion 526d, and is opposed to a tip end face 61 of the ground chip 60 in a mutually parallel. As shown in FIG. 9, a border line between the vertical portion 525d and the inclined portion 526d is illustrated by a dotted line DLL

Materials of the vertical portion 525d and the inclined portion 526d may also be the same as each other or be different from each other. For example, the inclined portion 526d may also be made of a noble metal alloy including platinum as a base material, and the vertical portion 525d may also be made of the same material (alloy including nickel as a base material) as the first part 510d.

Like the present embodiment, even when only the tip end of the second part 520d is non-perpendicular to the center axis AX51 of the first part 510d, not the entire second part 520d, an effect similar to one described in the first embodiment may be obtained. Incidentally, a shape of the vertical portion 525d may also be different from it shown in FIG. 9.

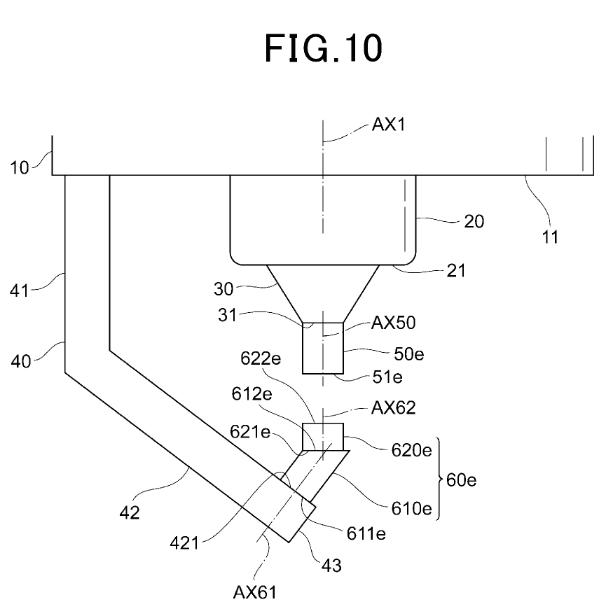

Referring to FIG. 10, a sixth embodiment will be described below. A spark plug 100 according to the sixth embodiment is different from the first embodiment in only shapes of a center chip 50e and a ground chip 60e. Other configurations are the same as those in the first embodiment. Different points in the sixth embodiment compared to the first embodiment will be described below.

The shape of the center chip 50e according to the present embodiment is the same as that of the ground chip 60 in the first embodiment. That is, the center chip 50e has a cylindrical shape, and a center axis AX50 thereof is perpendicular to a tip end face 31 of a center electrode 30. The center axis AX50 of the center chip 50e is aligned with a center axis AX1 of a mounting fitting 10. A tip end face 51e of the center chip 50e disposed at a position opposed to the ground chip 60e is perpendicular to the center axis AX50 of the center chip 50e.

The shape of the ground chip 60e is the same as that of the center chip 50 in the first embodiment. That is, the ground chip 60e includes a first part 610e and a second part 620e which are bonded with each other. Thereby, the ground chip 60e has a cylindrical shape so that a center axis thereof is bent in the middle.

The first part 610e is a ground electrode 40 side part of the ground chip 60e, and is bonded with a side face 421 of the ground electrode 40. The first part 610e has an approximately cylindrical shape. The first part 610e linearly extends from the side face 421 of the ground electrode 40 along a center axis AX61 of the first part 610e.

An end face 611e (i.e. an end face which is disposed apart from the second part 620e) of the first part 610e disposed at a position opposed to the ground electrode 40 is perpendicular to the center axis AX61 of the first part 610e. The first part 610e is welded and fixed in such a state that the end face 611e of the first part 610e is disposed on the side face 421 of the ground electrode 40. As a result, the first part 610e is connected with the side face 421 of the ground electrode 40 so that the center axis AX61 thereof is perpendicular to the side face 421 of the ground electrode 40.

An end face 612e of the first part 610e disposed at a position opposed to the second part 620e is non-perpendicular to the center axis AX61 of the first part 610e. In addition, the end face 612e of the first part 610e is perpendicular to the center axis AX50 of the center chip 50e. In other words, the end face 612e of the first part 610e and the tip end face 31 of the center electrode 30 face each other and are mutually parallel.

The second part 620e is a part of the ground chip 60e disposed at the center chip 50e side, and has a cylindrical shape. The second part 620e linearly extends from the end face 612e of the first part 610e along a center axis AX62 of the second part 620e. Both an end face 621e of the second part 620e at a position opposed to the first part 610e and a tip end face 622e of the second part 620e disposed at the center chip 50e side are perpendicular to the center axis AX62 of the second part 620e. The center axis AX62 of the second part 620e is aligned with the center axis AX50 of the center chip 50. Therefore, the tip end face 622e of the second part 620e and the tip end face 51e of the center chip 50e face each other in a mutually parallel.

In the above-described configuration, the ground electrode 40 side part of the ground chip 60e, that is the first part 610e, which is a part welded to the ground electrode 40, is perpendicular to the side face 421 of the ground electrode 40. Therefore, welding the ground chip 60e to the ground electrode 40 may be relatively easily performed. That is, in the present embodiment, an effect similar to one described in the first embodiment may be obtained.

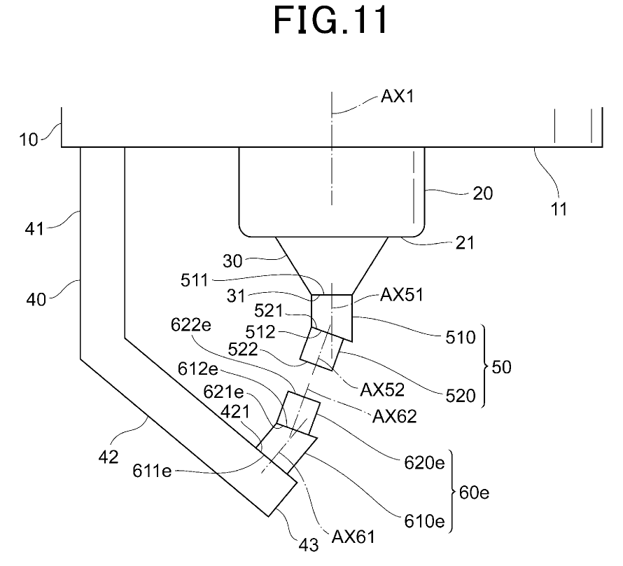

Referring to FIG. 11, a seventh embodiment will be described below. A spark plug 100 according to the seventh embodiment is different from the first embodiment in only shapes of a center chip and a ground chip. Other configurations are the same as those in the first embodiment. Different points in the seventh embodiment compared to the first embodiment will be described below.

The shape of the center chip of the present embodiment is approximately the same as that of the center chip 50 in the first embodiment (refer to FIG. 2). Accordingly, the center chip of the present embodiment is also indicated as “center chip 50”. The center chip 50 has a first part 510 and a second part 520. In the center chip 50 of the present embodiment, an angle formed by a center axis AX51 of the first part 510 and a center axis AX52 of the second part 520 is slightly larger than that of the first embodiment. That is, a bending degree of the center chip 50 is slightly smaller than one shown in FIG. 2 in the first embodiment.

The shape of the ground chip of the present embodiment is approximately the same as that of the ground chip 60e in the sixth embodiment (refer to FIG. 10). Accordingly, the ground chip of the present embodiment is also indicated as “ground chip 60e”. In the ground chip 60e of the present embodiment, an angle formed by a center axis AX61 of a first part 610e and a center axis AX62 of a second part 620e is slightly larger than one of the sixth embodiment. That is, a bending degree of the ground chip 60e is slightly smaller than one shown in FIG. 10 in the sixth embodiment. Accordingly, the center axis AX52 of the second part 520 is aligned with the center axis AX62 of the second part 620e. In addition, a tip end face 522 of the center chip 50 and a tip end face 622e of the ground chip 60e face each other and are mutually parallel.

In the above-described configuration, a part of the center chip 50 disposed at a center electrode 30 side, which is welded to the center electrode 30, is perpendicular to a tip end face 31 of the center electrode 30. Therefore, welding the center chip 50 to the center electrode 30 may be relatively easily performed. That is, in the present embodiment, an effect similar to one described in the first embodiment may be obtained.

A ground electrode 40 side part of the ground tip 60e, that is, a shape of a part of the first portion 610e, which is a part welded to the ground electrode 40, is perpendicular to the side face 421. Therefore, welding the ground chip 60e to the ground electrode 40 may be relatively easily performed. That is, in the present embodiment, an effect similar to one described in the sixth embodiment may be obtained.

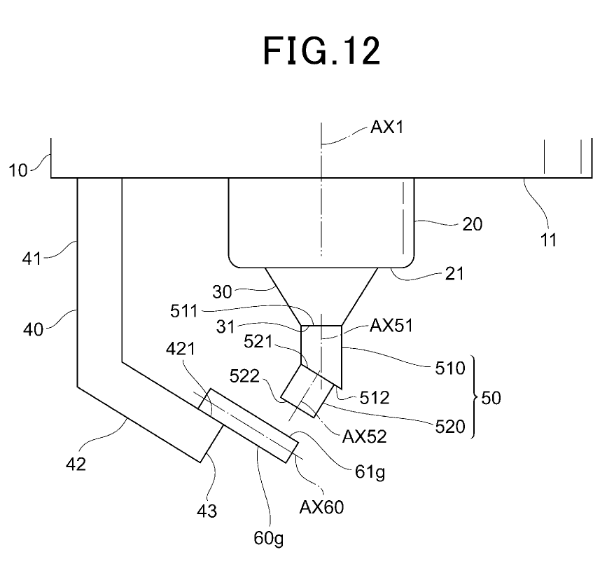

Referring to FIG. 12, an eighth embodiment will be described below. A spark plug 100 according to the eighth embodiment is different from the first embodiment in only shapes of a ground electrode and a ground chip 60g. Other configurations are the same as those in the first embodiment. Different points in the eighth embodiment compared to the first embodiment will be described below.

The shape of the ground electrode of the present embodiment is approximately the same as that of a ground electrode 40 in the first embodiment (refer to FIG. 2). Accordingly, the ground electrode of the present embodiment is also indicated as “ground electrode 40”. The center chip 50 has a first part 510 and a second part 520. In the ground electrode 40 of the present embodiment, a length of a part (part number 42) extending from a mounting fitting 10 to a tip end 43 of the ground electrode 40 other than a part of the ground electrode 40 arranged parallel relative to a center axis AX51 of the first part 510 is shorter than one in the first embodiment. Therefore, when viewing the ground electrode 40 along the center axis AX52 of the second part 520, the second part 520 of the center chip 50 and the part given the reference numeral 42 of the ground electrode 40 are not overlapped with each other.

The ground chip 60g of the present embodiment has a square prism shape. The ground chip 60g has a first end and a second end. In the ground chip 60g, the first end is perpendicular to the second end. The side face in the first end of the ground chip 60g is welded to a side face 421 of the ground electrode 40. The second end of the ground chip 60g is projected from the tip end 43 of the ground electrode 40 to a center axis AX1 of a mounting fitting 10. A center axis AX60 of the ground chip 60g is perpendicular to the center axis AX52 of the second part 520. Accordingly, in the second end of the ground chip 60g, a side face 61g of the ground chip 60g and a tip end face 522 of the center chip 50 face each other and are mutually parallel. In the above-described aspect, an effect similar to one described in the first embodiment may be obtained.

Incidentally, a material of the ground chip 60g may also be a noble metal alloy including platinum or iridium as a base material, and may also be an alloy including nickel as a base material.

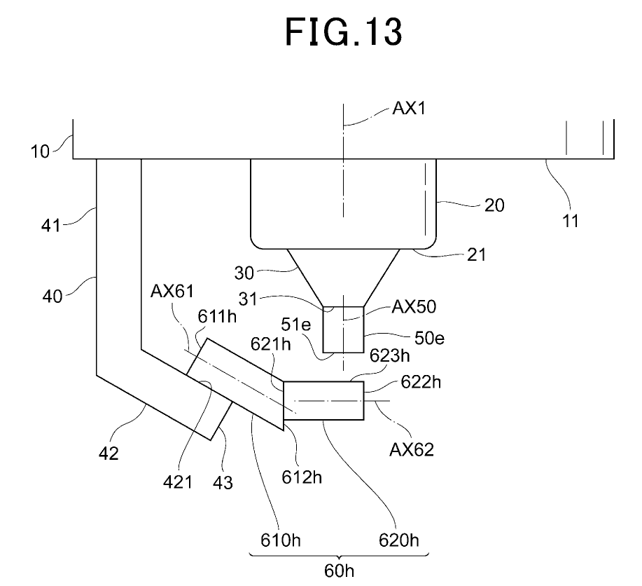

Referring to FIG. 13, a ninth embodiment will be described below. A spark plug 100 according to the ninth embodiment is different from the first embodiment in only shapes of a center chip, a ground electrode and a ground chip 60h. Other configurations are the same as those in the first embodiment. Different points in the ninth embodiment compared to the first embodiment will be described below.

The shape of the center chip of the present embodiment is the same as that of the center chip 50e in the sixth embodiment (refer to FIG. 10). Accordingly, the center chip of the present embodiment is also indicated as “center chip 50e”.

The shape of the ground electrode of the present embodiment is approximately the same as that of the ground electrode 40 in the first embodiment (refer to FIG. 2). Accordingly, the ground electrode of the present embodiment is also indicated as “ground electrode 40”. A length of a part (part number 42) extending from a mounting fitting 10 to a tip end 43 of the ground electrode 40 other than a part of the ground electrode 40 arranged parallel relative to a center axis AX50 of the center tip 50e is shorter than one in the first embodiment. Therefore, when viewing the ground electrode 40 along a center axis AX50 of the center chip 50e, the center chip 50e and the part given the reference numeral 42 of the ground electrode 40 are not overlapped with each other.

A shape of the ground chip 60h of the present embodiment is the same as that of the center chip 50a shown in FIG. 6 in the second embodiment. The ground chip 60h is formed by diffusion bonding a first part 610h with a second part 620h. The ground chip 60h has a square prism shape such that a center axis thereof is bent in the middle.

The first part 610h is a part of the ground chip 60h disposed at the ground electrode 40 side part of the ground chip 60h. A side face of the first part 610h is welded and fixed to a side face 421 of the ground electrode 40 in such a state that a center axis AX61 of the first part 610h and a part (part number 42) of the ground electrode 40 face each other and are mutually parallel. An end face 612h of the ground chip 60h disposed opposed to the second part 620h is non-perpendicular to the center axis AX61 of the first part 610h, and is arranged parallel relative to a center axis AX1 of a mounting fitting 10. In addition, in the ground chip 60h, an end face 611h of the first part 610h, which is opposed to the end face 612h, is perpendicular to the center axis AX61 of the first part 610h.

The second part 620h linearly extends from the end face 612h of the first part 610h along a center axis AX62 of the second part 620h. Both a side face 621h of the second part 620h, which is opposed to the first part 610h, and a tip end face 622h of the second part 620h, which is opposed to the side face 621h of the second part 620h, are perpendicular to the center axis AX62 of the second part 620h.

The center axis AX62 of the second part 620h is perpendicular to the center axis AX50 of the center chip 50e. Therefore, a side face 623h of the second part 620h, which is opposed to the center chip 50e, is perpendicular to the center axis AX50 of the center chip 50e. In addition, a tip end face 51e of the center chip 50e and the side face 623h of the second part 620h face each other and are mutually parallel. In a vicinity of the tip end face 622h of the second part 620h, the side face 623h of the second part 620h and the tip end face 51e of the center chip 50e face each other in a mutually parallel. In the above-described aspect, an effect similar to one described in the first embodiment may be obtained.

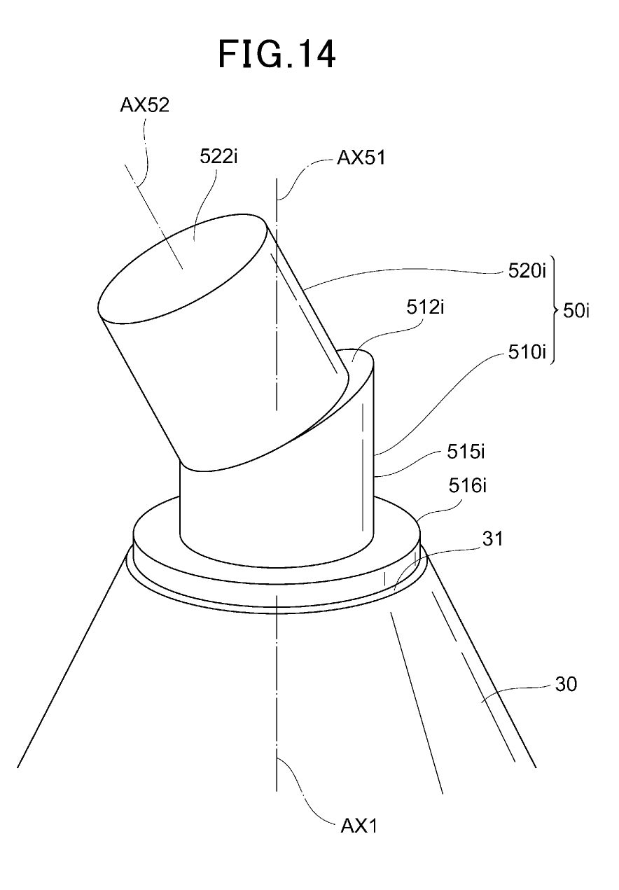

Referring to FIG. 14, a tenth embodiment will be describe below. A spark plug 100 according to the tenth embodiment is different from the first embodiment in only a shape of a center chip 50i. Other configurations are the same as those in the first embodiment. Different points in the tenth embodiment will be described below.

The center chip 50i has a first part 510i and a second part 520i. The first part 510i has a part given a reference numeral 515i and the diameter enlarged portion 516i. In the center chip 50i of the present embodiment, the diameter enlarged portion 516i is formed on a center electrode 30 side part of the first part 510i. The part given the reference numeral 515i has a first end face and a second end face facing each other. The diameter of the diameter enlarged portion 516i is larger than that of the first end face which is opposed to the diameter enlarged portion 516i. The diameter enlarged portion 516i is disposed at a position which is closest to the center electrode 30 in the first part 510i. A center axis of the diameter enlarged portion 516i is aligned with a center axis AX51 of the part given the reference numeral 515i and a center axis AX1 of a mounting fitting 10.

Incidentally, the part given the reference numeral 515i of the first part 510i has a diameter slightly smaller than the diameter of a first part 510 of the first embodiment. In addition, the second part 520i has a diameter one size smaller than the diameter of a second part 520 of the first embodiment.

In this way, in an aspect where diameters of the first end face and the second end face are both different from those of the diameter enlarged portion 516i and the second part 520i, an effect similar to one described in the first embodiment may be obtained.

As described above, referring to concrete examples, embodiments of the present disclosure has been described. However, the present disclosure is not limited to these concrete examples. That is, as long as items where those skilled in the art appropriately add design change to the concrete examples include the features of the present disclosure, they are included in the scope of the present disclose. For example, the above-described element, and a position, a material, a condition and a shape of the element included in each of the concrete examples may be appropriately changed, and are not limited to those illustrated. In addition, elements included in each of the embodiments can be combined as long as technically feasible, and are within the scope of the present disclosure as long as they include the features of the present disclosure.

What is claimed is:

1. A spark plug for an internal combustion engine, comprising:
a mounting fitting which has a cylindrical shape;
a center electrode which is disposed along a center axis of the mounting fitting, and the center electrode is mounted on the mounting fitting and electrically insulated from the mounting fitting;
a center chip which is projected from a part of the center electrode to outside of the spark plug;
a ground electrode which has a first end and a second end, the first end being fixed to the mounting fitting, and at least a part of the ground electrode is non-perpendicular to the center axis of the mounting fitting so that the ground electrode becomes closer to the center axis of the mounting fitting towards the second end; and
a ground chip which is mounted so as to project from a part of the ground electrode to the center chip,
wherein at least one of the center chip and the ground chip has a first part bonded with the center electrode or the ground electrode and is formed so as to linearly extend along a first center axis of an electrode bonded with the first part; and
a second part formed so as to extend linearly from a tip end of the first part along a second central axis inclined with respect to the first central axis.

2. A spark plug as set forth in claim 1, wherein,
a first end face of the first part at an opposite side of the second part is perpendicular to the first axis.

3. A spark plug as set forth in claim 2, wherein,
a material of the first part is different from that of the second part.

4. A spark plug as set forth in claim 3, wherein,
end faces formed on both ends of the second part are perpendicular to the second center axis.

5. A spark plug as set forth in claim 3, wherein,
a middle layer made of a material different from both of the materials of the first part and the second part is formed between the first part and the second part.

6. A spark plug as set forth in claim 5, wherein,
a linear expansion coefficient of the middle layer is smaller than that of the first part, and is larger than that of the second part.

7. A spark plug as set forth in claim 3, wherein,
the first part is made of an alloy including nickel, and the second part is made of a noble metal alloy.

8. A spark plug as set forth in claim 7, wherein,
the noble metal alloy is an alloy including platinum or iridium.
